(19) United States
(12) Patent Application Publication
(10) Pub. No.: US 2023/0028038 A1
(43) Pub. Date: Jan. 26, 2023

(54) CONFIGURATION OF ASSET MONITORING SYSTEMS

(71) Applicant: Baker Hughes Holdings LLC, Houston, TX (US)

(72) Inventors: Aaron R. Hampton, Minden, NV (US); Cody Worsnop, Houston, TX (US)

(21) Appl. No.: 17/861,407

(22) Filed: Jul. 11, 2022

Related U.S. Application Data
(60) Provisional application No. 63/221,927, filed on Jul. 14, 2021.

(51) Int. Cl. G06F 3/04847; G06F 9/451; G06F 9/445; G06F 3/0482

(52) U.S. Cl. CPC G06F 3/04847; G06F 9/451; G06F 9/44505; G06F 3/0482; G06F 2203/04803

(57) ABSTRACT

A method for configuring an asset monitoring system is provided. The method can include receiving a configuration including a configuration property of a measurement determined by an asset monitoring system configured to monitor an asset. The method can also include generating a graphical user interface including an identifier of the measurement and one or more configuration properties corresponding to the measurement. The method can also include validating the received configuration and receiving a selection of a measurement within the first window of the GUI. The method can further include updating the GUI to include a validation error corresponding to the selected measurement within a second window. The method can also include correcting the validation error and updating the GUI to include a third window listing at least one correction corresponding to the selected validation error. Related systems and non-transitory medium related to the method are also provided.

### CROSS-REFERENCE TO RELATED APPLICATIONS

The present application claims priority under 35 U.S.C. § 119 to U.S. Provisional Application No. 63/221,927 entitled “CONFIGURATION OF ASSET MONITORING SYSTEMS” filed on Jul. 14, 2021, which is expressly incorporated by reference herein in its entirety.

### BACKGROUND

Many industries, such as hydrocarbon extraction, refining, and power generation, can rely heavily upon operation of assets (e.g., machinery), and in some instances, continuous operation of such assets. In these environments, unplanned asset shutdown and/or failure can incur severe consequences, ranging from expenses due to loss of production and/or expenses, to potential injury to workers, amongst others. Given these risks, it can be common to monitor selected parameters of various assets during operation. Measurements of the operating parameters can provide an indication of the condition of a respective asset components, as well as the asset as a whole. As a result, deviations in asset operation from normal operation can be identified and addressed to avoid asset shutdown and/or failure. Thus, asset monitoring can provide a variety of long term benefits, such as lower production costs, reduced equipment down time, improved reliability, and enhanced safety.

### SUMMARY

Asset monitoring systems (e.g., protection monitoring systems and/or condition monitoring systems) can be configured acquire one or more measurements characterizing respective operating parameters of a monitored asset. These measurements can be further analyzed to determine whether an operating parameter is within or outside of pre-determined ranges for normal (safe) operation. As an example, set points can be used to define a normal operation range and measurement of operating parameters outside of this range can be logged (e.g., as alarms, warnings, etc.) In the context of protection monitoring systems, if a measured operating parameter is outside of a normal operating range, the protection monitoring system can control the monitored asset to bring the measured operating parameter within the normal operating range and/or halt operation of the monitored asset to avoid damage to the monitored asset. In the context of condition monitoring systems, measured operating parameters can be employed to make predictions regarding performance of the monitored asset and proactively identify potential asset damage or failure before it occurs.

Sensors can be used to acquire sensor signals characterizing operating parameters of the asset. Other computing devices can execute algorithms to analyze the sensor signals and determine operating parameters. With measurements of the operating parameters of the asset, protection and condition monitoring functions can be performed. However, these sensors and algorithms can require configuration in order to provide accurate operating parameter measurements.

Existing asset monitoring systems can be manually configured. That is, an operator can be required to manually enter one or more configuration properties for the sensors and/or algorithms to determine operating parameter measurements. However, such manual configuration can be complicated and tedious, as well as requiring significant domain expertise. Furthermore, configuration properties can differ between respective asset monitoring systems. Thus, special attention can be required to employ appropriate configuration properties and avoid errors. Additionally, when errors in configuration properties occur, they can be difficult to resolve, as the configuration properties can be complex and interrelated.

Accordingly, embodiments of the disclosure provide systems and methods for improved configuration of asset monitoring systems. As discussed in greater detail below, a configuration system can be employed in conjunction with an asset monitoring system to identify errors in configuration properties and generate graphical user interfaces (GUIs) facilitating resolution of such errors. As an example, the configuration system can determine one or more possible solutions to correct a selected error. The GUIs can display these correction options for consideration by an operator. Once an operator selects a correction, the configuration system can further update a configuration of the asset monitoring system to implement the selected correction.

In certain embodiments, the correction options can be based upon domain knowledge and best practices (e.g., as determined by a manufacturer of the asset monitoring system, operator of the asset monitoring system, and/or another authority). In further embodiments, the configuration system can be configured to automatically resolve configuration errors. As an example, one of the corrections for a validation error can be default. A default correction can be further associated with a configuration profile. Therefore, by selecting a configuration profile, the default correction can automatically implemented for one or more configuration errors.

Beneficially, this automation can significantly reduce the amount of time required for configuring an asset monitoring system, as it can help operators address errors that they would otherwise spend more time resolving manually. Furthermore, configuration best practices can be codified, reducing the level of domain knowledge required by operators to resolve configuration errors.

In an embodiment, a method for configuring an asset monitoring system is provided. The method can include receiving, by a configuration system including one or more processors, a configuration. The configuration can include at least one configuration property corresponding to a measurement determined by an asset monitoring system configured to monitor an asset. The method can also include generating, by the configuration system, a graphical user interface (GUI). The GUI can include a first window containing an identifier of the measurement and one or more configuration properties corresponding to the measurement. The method can further include outputting, by the configuration system, the GUI to a display device for display of the GUI. The method can also include validating, by the configuration system, the received configuration. The validation can include receiving a selection of a measurement within the first window of the GUI. The validation can also include comparing a configuration property of the one or more configuration properties to a corresponding reference configuration property. The validation can additionally include determining at least one validation error for the selected measurement when a configuration property of the one or more configuration properties does not satisfy its corresponding reference configuration property. The method can further include updating the GUI to include the at least one validation error corresponding to the selected measurement within a second window. The method can also include correcting, by the configuration system, a validation error of the at least one validation error corresponding to the selected measurement. The correcting can include receiving a selection of a validation error from the at least one validation error within the second window. The correcting can also include updating the GUI to include a third window listing at least one correction corresponding to the selected validation error.

In another embodiment, the at least one correction can include an updated configuration property for the measurement or component. The method can further include, by the configuration system, receiving, a selection of a correction from the at least one correction within the third window, updating the configuration to replace the configuration property with an updated configuration property corresponding to the selected correction, updating the GUI to include the updated configuration property within the first window and to remove display of the selected validation error within the second window, and transmitting the updated configuration property to the asset monitoring system.

In another embodiment, the GUI can be configured to, upon receipt of a second selection of a validation error, navigate the GUI to a portion of the first window containing the configuration property corresponding to the selected error. The method can further include, by the configuration system, receiving the second selection, receiving input of an updated configuration property corresponding to the selected error within the portion of the first window, updating the configuration to replace the configuration property with the updated configuration property, updating the GUI to include the updated configuration property within the first window and to remove the selected validation error from the second window, and transmitting the updated configuration property to the asset monitoring system.

In another embodiment, the at least one correction can be disabling the selected configuration property, and the method can further include, by the configuration system, receiving a selection of one of the at least one correction within the third window, updating the GUI to remove the selected at least one validation error from the second window, and transmitting information operative to disable the selected configuration property to the asset monitoring system.

In another embodiment, each of the at least one correction can be associated with a profile. The at least one correction can be an updated configuration property corresponding to the selected measurement. The method can further include, by the configuration system, receiving a selection of a configuration profile from a list of configuration profiles, automatically selecting the correction from the at least one correction associated with the selected configuration profile, updating the configuration to replace the configuration property with the updated configuration property corresponding to the selected correction, updating the GUI to include the updated configuration property within the first window and remove the selected validation error from the second window, and transmitting the updated configuration property to the asset monitoring system.

In another embodiment, the method can further include, by the configuration system prior to updating the configuration, updating the GUI to include a fourth window displaying each correction corresponding to the selected validation error and the automatically selected correction. The fourth window can be further configured to receive a user input of an updated correction different from the automatically selected correction. The selected correction can be automatically selected correction absent receipt of the updated correction and the selected correction can be the updated correction when the updated correction is received.

In another embodiment, the method can further include receiving user input confirming the displayed correction associated with the selected configuration profile prior to updating the configuration of the hardware component.

In another embodiment, the configuration property can include at least one of a scale factor, a linear range, a frequency response, or a health limit for a sensor in communication with the asset monitoring system.

In another embodiment, the configuration property can include at least one of a type of measurement or observation information defining at least a portion of the measurement to be observed.

In another embodiment, the configuration parameter can include at least one set point corresponding to a respective operating parameter measurement determined by the asset configuration system.

In another embodiment, each configuration profile can be associated with a state of the asset. The method can further include, by the configuration system, receiving a ruleset, determining a state of the monitored asset based upon the ruleset, and selecting the configuration profile that corresponds to the determined asset state.

### DESCRIPTION OF THE DRAWINGS

These and other features will be more readily understood from the following detailed description taken in conjunction with the accompanying drawings, in which:

FIG. 1 is a schematic block diagram illustrating one exemplary embodiment of an operating environment including a configuration system configured to configure an asset monitoring system;

FIG. 2A is a schematic block diagram illustrating one exemplary embodiment of the asset monitoring system of FIG. 1;

FIG. 2B is a table illustrating exemplary embodiments of circuits of the asset monitoring system of FIG. 2A;

FIG. 3 is a flow diagram illustrating one exemplary embodiment of a method for configuring the asset monitoring system of FIG. 1;

FIG. 4 is a schematic diagram illustrating one exemplary embodiment of a graphical user interface (GUI) generated by the configuration system of FIG. 1 including a navigation window, a configuration window, and an error window;

FIG. 5 illustrates the GUI of FIG. 4 displaying measurements and corresponding configuration properties within the configuration window;

FIG. 6 illustrates the GUI of FIG. 5 displaying a configuration error within the error window corresponding to a selected configuration property;

FIG. 7A illustrates the GUI of FIG. 5 displaying a correction window including configuration property corrections in response to selection of an error within the error window;

FIG. 7B illustrates selection of a correction listed in the correction window of the GUI of FIG. 7A;

FIG. 7C illustrates removal of the selected error from the error window of the GUI of FIG. 7A in response to selection of a correction listed in the correction window;

FIG. 8 illustrates navigation within the GUI of FIG. 5 to a portion of the configuration window corresponding to an error selected within the error window;

FIG. 9A illustrates the GUI of FIG. 5 displaying a profile menu within the error window listing respective configuration profiles;

FIG. 9B illustrates selection of a configuration profile from the profile menu and a selection (e.g., a Quick fix button) to implement automatic error correction within the GUI of FIG. 9A; and

FIG. 10 illustrates a confirmation window generated by the configuration system in response the selection to implement automatic error correction within the GUI of FIG. 9B.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Asset monitoring systems can be designed to measure and analyze various operating parameters of an asset in order to detect improper asset operation and to predict when damage to assets can occur. In this manner, corrective action can be taken for control of the asset and/or maintenance of the asset, avoiding expensive asset downtime and repair. Existing asset monitoring systems can manually configure the asset monitoring system to provide configuration properties necessary to perform these functions. However, manual configuration is subject to errors, such as entry of incorrect configuration properties or omission of configuration properties. Furthermore, in some cases, these configuration errors can require significant time and/or expertise to identify and correct. Accordingly, embodiments of the present disclosure provide systems and methods for improved configuration of asset monitoring systems. As discussed in greater detail below, a configuration system can be used to identify configuration errors and to generate graphical user interfaces (GUIs) that facilitating correction of such errors. In one example, the configuration system can determine possible corrections for a selected error. In another example, the configuration system can recommend one of the possible corrections and automatically resolve errors using the recommended correction. Beneficially, this can significantly reduce the amount of time and knowledge required to configuring the asset monitoring system.

Embodiments of systems and corresponding methods for configuration of asset monitoring systems are discussed herein. However, embodiments of the disclosure can be employed for configuration of other systems without limit.

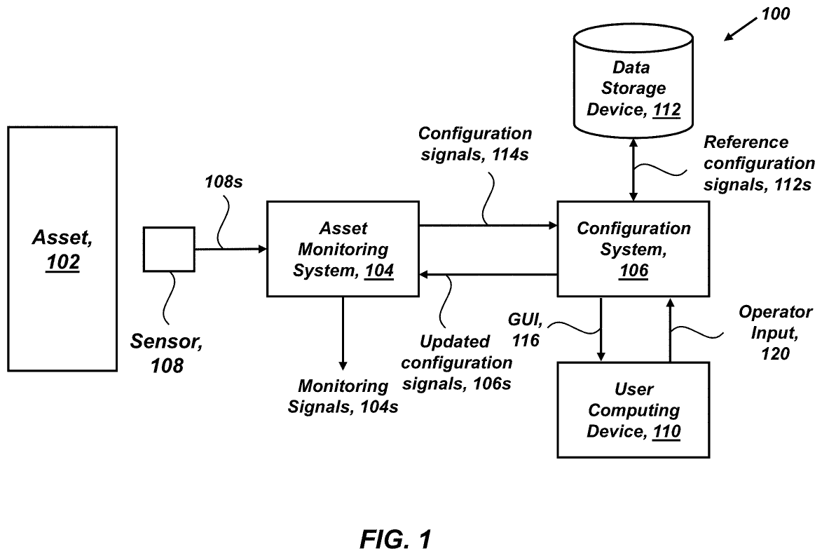

FIG. 1 is a schematic block diagram illustrating one exemplary embodiment of an operating environment 100 including an asset 102, an asset monitoring system 104, a configuration system 106, a user computing device 110, and a data storage device 112. The configuration system 106 can be in communication with the asset monitoring system 104, the user computing device 110, and the data storage device 112 via a network.

Embodiments of the asset 102 can include one or more machines or machine components for that are monitored by the asset monitoring system 104. In certain embodiments, the asset 102 can be a machine including one or more components (e.g., rotating components, reciprocating components, and/or fixed asset components). Such components can include, but are not limited to, gears, bearings, and shafts, amongst others. Examples of machines containing such components can include, but are not limited to, turbomachines, turbines (e.g., hydro, wind), generators, and reciprocating compressors, amongst others.

The asset monitoring system 104 can be in communication with one or more sensors 108 that are configured to generate one or more sensor signals 108s representative of respective operating parameters of the asset 102. The sensors 108 can be further configured to transmit the sensor signals 108s to the asset monitoring system 104 (e.g., via field wiring).

In use, the asset monitoring system 104 can be configured to analyze the received sensor signals 108s and output one or more monitoring signals 104s representative of respective measurements. In one aspect, the measurements can be measurements of operating parameters of the asset. The asset monitoring system 104 can also be configured to analyze operating parameter measurements to determine a status (e.g., OK, not OK, alert, danger, etc.) of one or more monitored machines and/or machine components. As an example, operating parameter measurements can be compared to predefined set points or other criteria to determine respective alarms. Measured operating parameters, alarms and/or results from other analyses of measured operating parameters can be output from the asset monitoring system 104 as monitoring signals 104s.

The asset monitoring system 104 can require configuration properties in order to determine the operating parameter measurements from the received sensor signals 108s, and/or to analyze the operating parameter measurements. The configuration properties can be managed by the configuration system 106. As discussed in greater detail below, the configuration system 106 can include one or more processors that receive a configuration from the asset monitoring system 102. The configuration can include at least one configuration property corresponding to a measurement determined by the asset monitoring system 102. Upon receipt of the configuration, the configuration system 106 can generate a graphical user interfaces (GUI) 116 that includes a first window containing an identifier of the measurement and one or more configuration properties corresponding to the measurement. The GUI 116 can be output to a display device for display of the GUI 116. As an example, the user computing device 110 can include the display device and thus the GUI 116 can be transmitted to the user computing device 110 for display.

The configuration system 106 can be further configured to validate the received configuration. As an example, the configuration system 106 can receive an operator input 120 (e.g., via the user computing device 110) including selection of a measurement within the first window. The configuration system 106 can further compare at least one configuration property of the one or more configuration properties of the selected measurement to a corresponding reference configuration property. As an example, reference configuration properties can be retrieved from the data storage device 112 (e.g., reference configuration signals 112s). Under circumstances where the at least one configuration property does not match its corresponding reference configuration property, at least one validation error can be determined for the measurement. The configuration system 106 can update the GUI 116 to include the validation error for the selected measurement in a second window.

The configuration system 106 can be further configured to correct the determined validation errors. As an example, the configuration system 106 can receive operator input 120 that selects a validation error within the second window of the GUI 116. In response to receipt of this selection, the configuration system 106 can further update the GUI 116 to include a third window displaying at least one correction corresponding to the selected validation error.

As discussed in greater detail below, the configuration system can be configured to automatically update the configuration to replace the configuration property with an updated configuration property according to one of the corrections. In further embodiments, this correction can be a correction that is recommended by an authority (e.g., a manufacturer of the asset monitoring system 104, an operator of the asset monitoring system 104, etc.) In this case, the GUI 116 can be further updated by the configuration system 106 to replace the erroneous configuration property with the updated configuration property within the first window. The configuration system 106 can also transmit the updated configuration to the asset monitoring system 104 (e.g., via updated configuration signals 106s) for subsequent use.

In this manner, the configuration system 106 can provide a variety of benefits. In one aspect, the recommended correction can reflect current best practices. Thus, the level of domain expertise required to correct validation errors using embodiments of the configuration system 106 can be reduced. In another aspect, use of the configuration system 106 can automatically detect and resolve validation errors, providing a significant time savings as compared to manual detection and resolution of validation errors, as well as improved configuration consistency. As a result, overall usability of the asset monitoring system 104 and the operator experience can be significantly enhanced, as compared to asset monitoring systems that do not employ the configuration system 106.

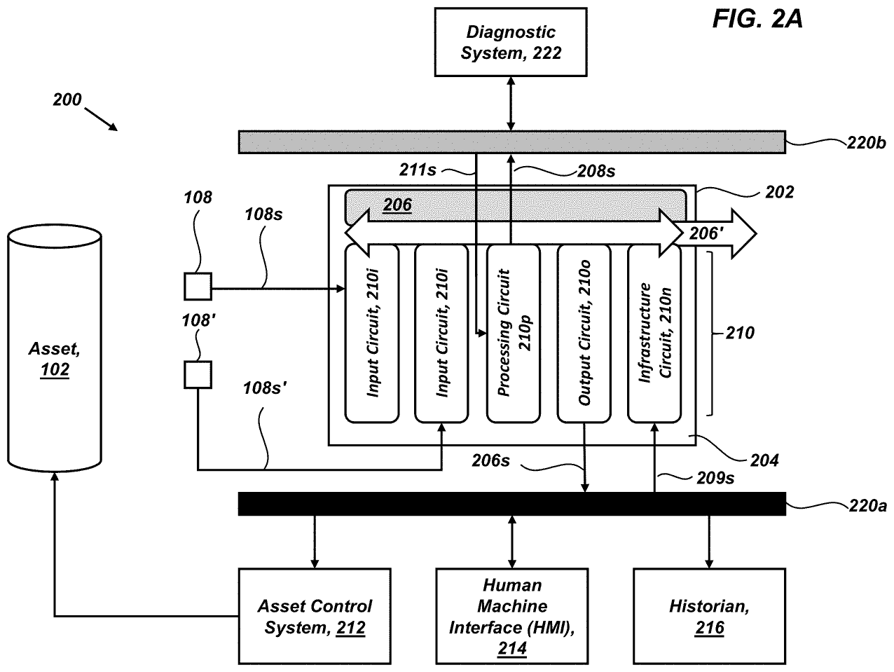

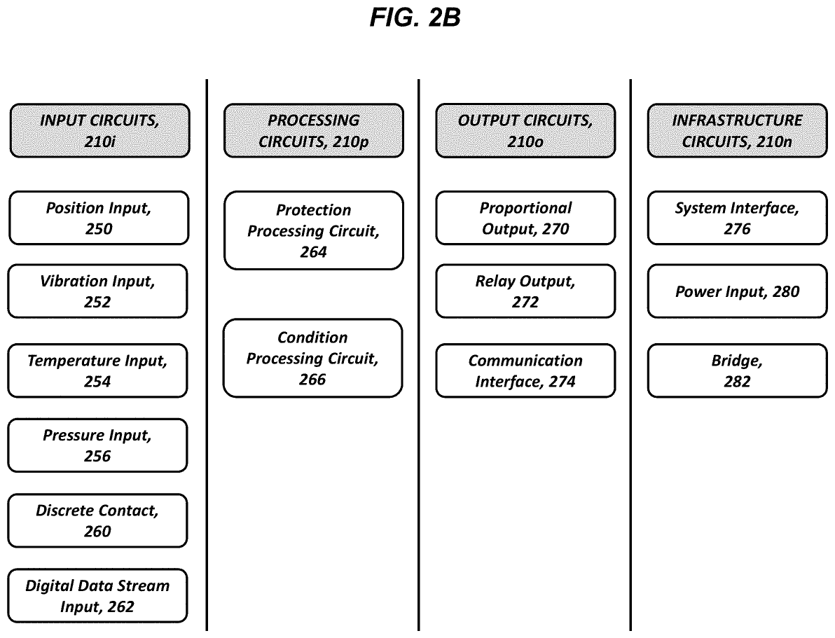

To better understand embodiments of the configuration system 106, an embodiment of the asset monitoring system 104 in the form of asset monitoring system 202 is illustrated and discussed in detail below with reference to FIG. 2. As shown, the asset monitoring system 202 includes a base 204 containing a backplane 206, and one or more circuits 210. The backplane 206 can be configured to communicatively couple with two or more circuits 210 and receive data from at least one circuit 210 coupled thereto. As discussed herein, data transmitted to the backplane 206 can be referred to as monitoring data. In one aspect, monitoring data can include information contained within the sensor signals 108s.

As an example, the sensors 108 can include a probe, a transducer, and a signal conditioning circuit (not shown). The probe can interact with the asset 102 to acquire measurements of physical phenomena that characterize an operating parameter of the asset 102. The transducer can convert measurements of the physical phenomena into an electrical signal (e.g., a voltage), and the signal conditioning circuit can condition and/or amplify the electrical signal to generate the sensor signals 108s (e.g., a voltage ranging between a minimum and maximum). Thus, in one aspect, the sensor signals 108s can contain the direct or raw measurement made by the sensor transducer. The sensor signals 108s can be analog signals or digital signals.

In another aspect, the sensor signals 108s can also include an enhanced data set, in addition to the direct measurements of the operating parameter. The enhanced data set can contain a variety of measured variables that depend upon the type of operating parameter being measured. As an example, the asset 102 can be a rotating component, such as a shaft, and radial vibration can be a variable measured by a sensor 108 in the form of a proximity sensor. Under these circumstances, the enhanced data set can include one or more of a gap voltage, a 1× filtered amplitude, a 2× filtered amplitude, a 1× filtered phase, a 2× filtered phase, Not 1× amplitude, and maximum shaft displacement (Smax). Gap voltage is the voltage output by the probe and represents the physical distance between the asset 102 and a tip of the probe. 1× amplitude is the amplitude of vibrations having the same frequency as the shaft rotation, while 2× amplitude is the amplitude of vibrations having a frequency twice that of the shaft rotation. For instance, a rotation speed of 1480 revolutions per minute corresponds to a frequency of 24.66̅ cycles per second (Hz). Phase is the time delay between a vibration measured at a predetermined measurement location with respect to a reference location. Thus, 1× phase refers to phase of vibrations having the same frequency as the shaft rotation, while 2× phase refers to phase of vibrations having a frequency twice that of the shaft rotation. Not 1× amplitude refers to all amplitudes except for the 1× amplitude. In other embodiments, the enhanced data set can include metadata regarding one or more components of the sensor 108, such as the transducer. Examples of metadata can include one or more of a serial number, revision number, operating temperature, and state of health.

Accordingly, monitoring data can include raw measurements characterizing respective operating parameters of the asset 102. Monitoring data can also include any values, statuses, and/or annunciated alarms that are determined based upon the measured operating parameters of the asset 102 and/or measured variables of the enhanced data set.

In another aspect, the sensor signals 108s can include information in addition to the direct measurements of an operating parameter. As an example, the sensor signals 108s can include metadata regarding one or more components of the corresponding sensors 108, such as the transducer. Examples of metadata can include, but is not limited to, one or more of a serial number, revision number, operating temperature, and state of health.

The number and type of sensors 108 can be dictated by the operating parameter(s) that are intended to be measured. In one aspect, the sensors 108 can take the form of one or more proximity probes for measurement of vibration, position, speed, direction of motion, and eccentricity. In another aspect, the sensors 108 can take the form of one or more accelerometers for measurement of seismic vibration and acceleration. In a further aspect, the sensors 108 can take the form of one or more temperature probes or pressure probes for measurement of temperature and pressure, respectively. It can be understood that the types of sensors 108 and corresponding measured operating parameters discussed above are not exhaustive and embodiments of the sensors 108 can include any sensor or combination of sensors suitable for measurement of operating parameters of interest.

The circuits 210 coupled to the backplane 206 can retrieve monitoring data from the backplane 206. In certain embodiments, the backplane 206 can be passive. A passive backplane can contain substantially no or no logical circuitry that performs computing functions. Desired arbitration logic can be placed on daughter cards (e.g., one or more of the circuits 210) plugged into or otherwise communicatively coupled to the passive backplane.

The circuits 210 can be designed with a common architecture that is programmable to perform different predetermined functions of the asset monitoring system 202. Sensor signals 108s received by one or more of the circuits 210 can be transmitted to the backplane 206 and monitoring data represented by the sensor signals 108s can be accessed by any circuit 210. Furthermore, the asset monitoring system 202 can communicatively couple multiple bases in a manner that forms a common backplane 206′ from the individual backplanes 206 of each base 204 (e.g., a logical backplane). Thus, circuits 210 can retrieve monitoring data from any backplane 206 forming the common backplane 206′, rather than just from the backplane 206 to which they are physically coupled.

Exemplary embodiments of circuits 210 are illustrated in FIG. 2B and are discussed in detail below. As an example, circuits 210 can include input circuits 210i, processing circuits 210p, output circuits 210o, and infrastructure circuits 210n. It can be understood, that the circuits 210 can also be programmed to perform other functions, as necessary. Further discussion of the circuits 210 can also be found in U.S. patent application Ser. No. 15/947,716 entitled “Gated Asynchronous Multipoint Network Interface Monitoring System,” the entirety of which is incorporated by reference. Accordingly, the asset monitoring system 202 can be configured to receive sensor signals 108s and output the monitoring signals 104s in the form of monitoring signals 206s, 208s to the internal and external networks 220a, 220b, respectively.

The internal network 220a can be a plant network that is in communication with an asset control system 212. The asset control system 212 can be configured to provide commands to an asset 102 that are operative to control one or more operating parameters of the asset 102. The internal network 220a can also be in communication with other systems, such as computing devices executing configuration software (e.g., the configuration system 106), human-machine interfaces (HMIs) 216 and/or a customer historian 216.

The external network 220b can be a business network that is in communication with a diagnostic system 222. The diagnostic system 222 can analyze any of the data contained within the monitoring signals 208s to diagnose improper operation of the asset 102 and/or predict improper operation of the asset 102 before it occurs. Thus, providing monitoring signals 208s to the external network 220b can facilitate condition monitoring of the asset 102.

As discussed above, the configuration system 106 can be used to provide configuration information to the asset monitoring system 104. The HMI 214 can be one or more computing devices in communication with user interface devices (e.g., displays) allowing an operator of the machine to review measured operating parameters and/or provide instructions to the asset control system 212. The asset monitoring system 202 can receive command signals 209s, 211s from the internal and external networks 220a, 220b, respectively, without compromising security of the asset control system 212.

The circuits 210 can be combined in various ways on one or more backplanes 206 to form different implementations of the asset monitoring system 202. The number of bases 204, input circuits 210i, processing circuits 210p, output circuits 210o, and infrastructure circuits 210n included in a given implementation of the asset monitoring system 202 can also be varied independently of one another. In some implementations, the asset monitoring system 202 can be in the form of a single base 204 including circuits 210 configured to provide signal input, signal output, protection monitoring, condition monitoring, and combinations thereof. In other implementations, the asset monitoring system 202 can be in the form of at least two bases 204 and circuits 210 configured to perform any combination of signal input, signal output, protection monitoring, and condition monitoring can be distributed between the at least two bases 204. In this manner, the input, processing, and output capabilities of the asset monitoring system 202, as well as the physical location of different circuits 210 of the asset monitoring system 202, can be tailored to specific monitoring applications.

In certain embodiments, input circuits 210i can be configured to receive sensor signals 108s, perform signal conditioning on the sensor signals 108s, and output the conditioned sensor signals 108s to the backplane 206. The input circuits 210i can be decoupled from processing circuits 210p, allowing the number of input circuits 210i of the asset monitoring system 202 to be varied independently of the number of processing circuits 210p.

The sensor signals 108s can be received from a variety of different types of sensors 108. Examples of sensor types can include, but are not limited to, vibration sensors, temperature sensors (e.g., resistance temperature detectors or RTD), position sensors, and pressure sensors.

Embodiments of the asset monitoring system 202 can include one or more input circuits 210i. As shown in FIG. 2A, the asset monitoring system 202 includes two input circuits 210i. Each of the input circuits 210i can be in communication with a respective sensor 108, 108′ for receipt of a corresponding sensor signal 108s, 108s′. As an example, the sensor signal 108s can represent first monitoring data including measurements of a first operating parameter of a first machine component (e.g., acquired by sensor 108). The sensor signal 108s′ can represent second monitoring data including measurements of a second operating parameter of a second machine component (e.g., acquired by the sensor 108′). In certain embodiments, the first and second machine components can be the same (e.g., the asset 102). In other embodiments, the first and second machine components can be different (e.g., the asset 102 and a different asset [not shown]). Similarly, in some embodiments, the first and second operating parameters can be the same operating parameter. In one aspect, this configuration can provide redundancy in case of failure of one of the sensors 108, 108′. In another aspect, this configuration can be utilized where a desired measurement (e.g., shaft rotation speed) is derived from two sensor measurements coordinated in time (phase). In additional embodiments, the first and second operating parameters can be different. While two input circuits 210i have been illustrated and discussed, other embodiments of the monitoring system can include greater or fewer input circuits.

Different types of sensors 108 can generate sensor signals 108s in different formats, and the input circuits 210i can be programmed to perform signal conditioning appropriate to the different sensor signals 108s before transmitting conditioned sensor signals to the backplane 206. As an example, a sensor signal 108s generated from a position sensor can be received by a position input circuit 250. A sensor signal 108s generated by a vibration sensor can be received by a vibration input circuit 252. A sensor signal 108s generated by a temperature sensor can be received by a temperature input circuit 254. A sensor signal 108s generated by a pressure sensor can be received by a pressure input circuit 256.

In other embodiments, the input circuit 210i can be in the form of a discrete contact circuit 260. The discrete contact circuit 260 can include a pair of contacts that can be closed by an external switch or relay. The pair of contacts can be closed by the asset control system 212 or by an operator of the asset control system 212 closing a switch. The discrete contact circuit 260 can be used to change the behavior of the asset monitoring system 202. Examples of behavior changes can include, but are not limited to, a different mode of machine operation, causing the asset monitoring system 202 to inhibit alarm determination, and resetting alarm states.

While the asset monitoring system 104 can include a discrete contact, it can lack specificity. As an example, changes effected by closing a discrete contact in the asset monitoring system 104 can be effected upon all alarms generated by the asset monitoring system 104. In contrast, because the discrete contact circuit 260 of the asset monitoring system 202 can be separate from the protection processing circuit 264, the discrete contact circuit 260 can be configured to effect only selected alarm determinations and/or reset alarm states, or effect all alarms.

In further embodiments, the input circuit 210i can be in the form of a digital data stream input circuit 262. As an example, the digital data stream input circuit 262 can be configured to receive digital data streams from the sensor 108, the asset control system 212, and/or a trusted third-party system, as opposed to an analog data stream (e.g., from sensor 108).

Processing circuits 210p can be configured to retrieve any data from the backplane 206, analyze the retrieved operating parameters, and output the results of such analysis. In certain embodiments, the processing circuits 210p can be configured to perform protection functions and can be referred to as protection processing circuits 264 herein. In other embodiments, the processing circuits 210p can be configured to retrieve selected data from the backplane 206 and transmit the retrieved information to a diagnostic system 222 for performing diagnostic and/or predictive functions (e.g., condition monitoring) and can be referred to as condition processing circuits 266 herein.

The number of processing circuits 210p and input circuits 210i included in a given implementation of the asset monitoring system 202 can be varied independently of the one another. In certain embodiments, processing circuits 210p can be added to the backplane 206 or removed from the backplane to tailor the amount of computing resources available for protection monitoring and/or condition monitoring. In other embodiments, a given processing circuit 210p can be replaced by another processing circuit 210p having greater or less computing power.

The protection processing circuits 264 and the condition processing circuits 266 are discussed below with reference to different functionalities. However, protection processing circuits 264 can be programmed to perform any function of the condition processing circuits 266. Condition processing circuits 266 can be programmed to perform functions of the protection processing circuits 264, except for transmitting data to the backplane 206 and providing local storage. The ability to inhibit the condition processing circuit 266 from transmitting data to the backplane 206 can inhibit unauthorized intrusion and facilitate protection of the internal network 220a and asset control system 212.

Protection processing circuits 264 can be configured to retrieve selected monitoring data from the backplane 206 in response to receipt of a protection command. As an example, one or more protection commands can be transmitted to protection processing circuits 264 in the form of protection command signal 209s received from the internal network 220a (e.g., from an operator of the asset control system 212). The selected monitoring data can include at least a portion of the monitoring data transmitted to the backplane 206. The monitoring data transmitted to the backplane can be received from an input circuit 210i or another protection processing circuit 264. The protection processing circuits 264 can also be configured to determine a value characterizing the selected monitoring data and transmit the determined value to the backplane 206 as additional monitoring data.

The protection processing circuit 264 can be configured to determine a status for the selected monitoring data based upon a comparison of the determined value, another determined value retrieved from the backplane 206 (e.g., from another protection processing circuit 264), and combinations thereof, with one or more predetermined set points. Predetermined set points can correspond to respective alarm conditions (e.g., an Alert condition, a Danger condition, etc.). Continuing the example above, where the determined value is an amplitude of a radial vibration, the one or more set points can include an Alert set point, a Danger set point that is greater than the Alert set point, and combinations thereof. In certain embodiments, a single set point can be employed. Assuming the use of Alert and Danger set points, if the radial vibration amplitude value is less than the Alert set point, the status of the radial vibration amplitude can be determined as “OK.” If the radial vibration amplitude value is greater than or equal to the Alert set point, the status of the radial vibration amplitude can be determined as “Alert.” If the radial vibration amplitude value is greater than the Danger set point, the status of the operating parameter can be determined as “Danger.” After the status of the selected monitoring data is determined in this manner, the protection processing circuit 264 can transmit the determined status to the backplane 206. The condition processing circuit 266 can be configured to retrieve selected monitoring data from the backplane 206 and to provide the retrieved monitoring data to the external network 220b for use by diagnostic system 222.

In certain embodiments, the selected monitoring data can be retrieved by the condition processing circuit 266 in response to receipt of a conditioning command. As an example, one or more conditioning commands can be transmitted to condition processing circuits 266 in the form of conditioning command signals 211s can be received from the external network 220b. (e.g., from an operator of the diagnostic system 222). In turn, the diagnostic system 222 can utilize the retrieved monitoring data to determine the cause of statuses and/or alarm conditions. Alternatively or additionally, the diagnostic system 222 can also employ the retrieved monitoring data to predict the development of statuses and/or alarm conditions before they arise. In further embodiments, the diagnostic system 222 can store the retrieved monitoring data for subsequent analysis. In additional embodiments, the diagnostic system 222 can transmit the retrieved monitoring data to another computing device for analysis.

In further embodiments, the condition processing circuit 266 can retrieve selected monitoring data from the backplane 206 based upon detection of a pre-determined status. As an example, the condition processing circuit 266 can retrieve and review statuses generated by the protection processing circuit 264 to identify a status matching the pre-determined status. The identified status can also include a status time characterizing the time when the status was determined. Upon identification of a match, the condition processing circuit 266 can retrieve selected monitoring data including operating parameter measurements corresponding to the pre-determined status for time durations before and/or after the status time. In this manner, the diagnostic system 222 can be provided with operating parameter information relevant to determining the cause of the status. The pre-determined statuses and selected monitoring data can be contained within the one or more conditioning commands.

Output circuits 210o can be configured to obtain any monitoring data contained on the backplane 206 in response to receipt of output commands (e.g., contained in the one or more protection command signal 209s received from the internal network 220a). The output circuits 210o can further output the retrieved monitoring data to the internal network 220a in the form of monitoring signals 206s. Examples of monitoring data retrieved by output circuits 210o can include, but are not limited to, operating parameter measurements, the determined values, variables of the enhanced data set, statuses, and alarms.

In one aspect, output circuits 210o can be in the form of proportional output circuits 270. The proportional output circuits 270 can be configured to output monitoring signals 206s in the form of process control signals. The process control signals can be proportional to process variables, such as direct measurement values or variables of the enhanced data set, as compared to a predetermined scale. As an example, a current output can be a 4-20 mA output. The process control signals can be provided to the asset control system 212, either directly or via the internal network 110a, to facilitate control of operating parameters of the asset 102. The process variables included in the process control signals can be specified by the protection command signal 209s.

In further embodiments, output circuits 210o can be in the form of one or more relay circuits 272 configured to retrieve selected status data from the backplane 206 and to actuate based upon received alarm statuses to annunciate an alarm. Annunciated alarms can be output in the form of alarm signals. In one example, relays can actuate based upon a single status. In another example, relays can actuate based upon predetermined Boolean expressions (e.g., AND or voting) that combine two or more statuses. The alarm signals can be provided to the asset control system 212 via the internal network 220a, or directly to the asset control system 212, to facilitate control of operating parameters of the asset 102. As an example, the asset control system 212 can shut down operation of the asset 102 in response to receipt of an alarm signal. The selected status data and the logic employed for actuation of a relay can be specified by the protection command signal 209s.

In other embodiments, output circuits 210o can be in the form of at least one communication interface circuits 274. The communication interface circuit 274 can be configured to retrieve selected monitoring data from the backplane 206 in response to receipt of the protection command signal 209s. The selected monitoring data can include one or more of the measured operating parameters, the measured variables of the enhanced data set, determined statuses, and determined alarms. The retrieved data can be transmitted to the internal network 220a in one or more return signals for use by the asset control system 212 (e.g., for process control), the HMI 214 (e.g., display to an operator) and/or stored by the historian 216.

Infrastructure circuits 210n can be configured to perform functionality required for the asset monitoring system 202 to operate. In one aspect, infrastructure circuits 210n can take the form of a system interface circuit 276. The system interface circuit 276 can function as an access point for transmission of protection command signals 209s from the internal network 110a to the diagnostic system 222, facilitating configuration of the circuits involved in protection monitoring (e.g., protection processing circuit 264, output circuits 210i). The protection command signals 209s can include one or more signals including any of the following in any combination: identification of selected monitoring data for each of the protection processing circuit 264 and output circuits 210i to retrieve and/or output, alarm set points for the protection processing circuit 264, and logic for annunciation of relays by relay output circuits 272.

In another aspect, infrastructure circuits 210n can take the form of power input circuits 280. Power input circuits 280 can provide the ability to connect one or more power sources to the asset monitoring system 202.

In a further aspect, infrastructure circuits 210n can take the form of bridge circuits 282. The bridge circuits 282 can provide the ability to connect the backplanes 206 of two or more bases 204 together and to form the common backplane 206′ for communication therebetween.

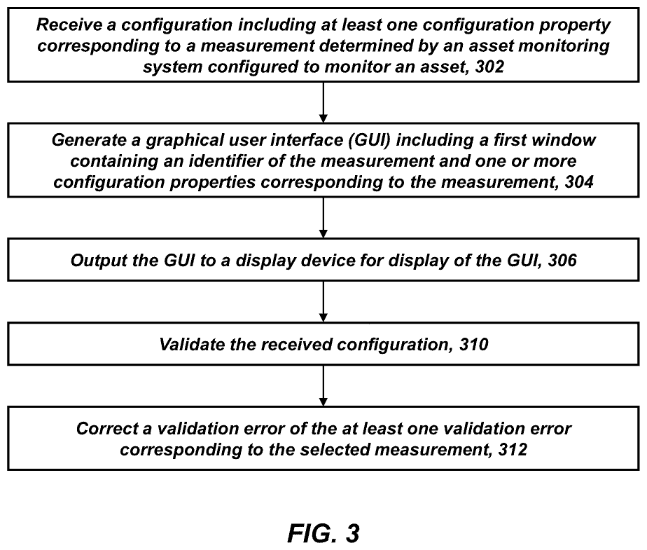

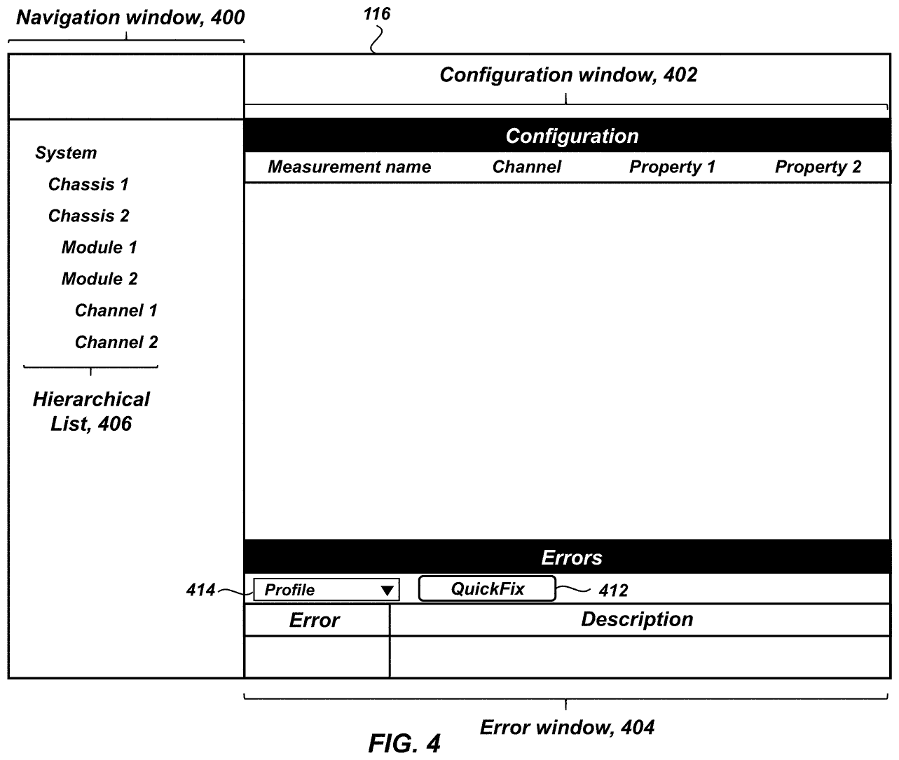

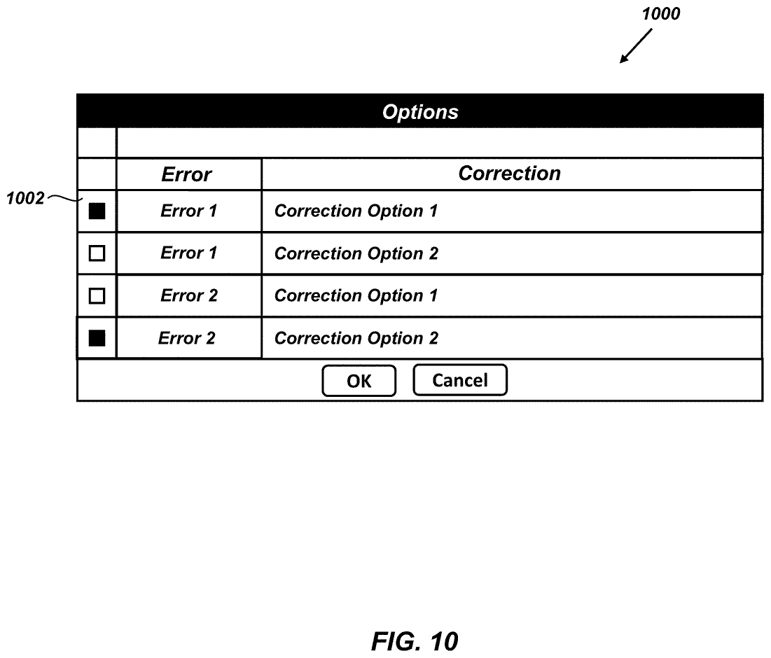

With a fuller understanding of the asset monitoring system 104, the discussion now turns to the configuration system 106. An exemplary embodiment of a method 300 employing the configuration system 106 for configuration of the asset monitoring system 104 is illustrated in FIG. 3. As shown, the method 300 includes operations 302-312. However, it can be appreciated that alternative embodiments of the method can include greater or fewer operations and/or can be performed in a different order than illustrated in FIG. 3. Exemplary embodiments of GUIs 116 generated by the configuration system 106 are further illustrated in FIGS. 4-10.

In operation 302, a configuration can be received by one or more processors (e.g., the configuration system 106). The configuration can include at least one configuration property corresponding to a measurement determined by the asset monitoring system 104. As discussed in greater detail below, the configuration system 106 can received from at least one of the data storage device 112 or the asset monitoring system 104 in response to a query.

In certain embodiments, the configuration property can pertain to a hardware component of the asset monitoring system 104 employed to determine a measurement. As an example, hardware components of the asset monitoring system 104 can include, but are not limited to, the circuits 210 (e.g., input circuits 210i, processing circuits 210p, output circuits 210o, and/or infrastructure circuits 210n). In other embodiments, the configuration property can pertain to logical processes (e.g., calculations, analyses, etc.) performed by the asset monitoring system 104 to determine a measurement.

In one embodiment, the configuration property can be one or more sensor information. The sensor information can be information about the hardware (e.g., sensors 108, output of sensor signals 108s), and/or calculations (e.g., algorithms or other logical processes) performed to determine operational parameters of the asset 102 from the sensor signals 108s. That is, the sensor information can pertain to obtaining the operating parameter measurements. Examples can include, but are not limited to:
Scale factor—a conversion between the measured operating parameter and the sensor signal 108 (e.g., a voltage). For example, a proximity transducer can employ a scale factor that sets the output voltage per unit distance.
Linear range—A range over which the sensor signal 108 (sensor output) is approximately linear with respect to the measured operating parameter (sensor input). It some cases it can be preferred to operate within the linear range. For example, in the context of a sensor having an output range between 0-20 V, the linear range could be 5-15 V.
Frequency response—How quickly the sensor can respond to changes in the measured operating parameter.
Health limits—Ranges of the sensor signal 108s that correspond to a state of the sensor 108 corresponding to the received sensor signal 108s. Examples of such states can include, but are not limited to, sensor off or on, sensor within or outside of linear range, sensor present or absent, etc.
Measurement calculation—Any information (e.g., mathematical formulae) used to determine operational parameter measurements from the sensor signals 108s.

In another embodiment, the configuration property can be one or more measurement information. The measurement information can be used to determine how the operating parameter measurements are used. Examples can include, but are not limited to:
Type of measurement—Identification of what the operating parameter measurement is. Examples can include, but are not limited to, bias, gap, bandpass, NX, synchronous, crest factor, peak-to-peak, etc.
Observation information—Given a type of measurement, the observation information can define what at least a portion of the measurement that is to be observed. For example, in the context of a bandpass, the observation information can define signal frequencies that are allowed to pass through and those which are not allowed to pass through and are rejected.

In an embodiment, the configuration property can be a set point. As discussed above, the asset monitoring system 104 can be configured to determine conditions (e.g., alarm conditions, warning conditions, etc.) based upon comparison of operational parameter measurements with one or more set points. As an example, an alarm condition can be determined when the operational parameter measurement is one or more of over a set point, under a set point, or outside a range of set points.

In a further embodiment, the configuration property can be a state of the asset. Examples of asset state can include, but are not limited to, operating modes of the asset 102, such as startup, shutdown, and steady state. The configuration property can also include one or more asset state configuration properties that can be used to determine the asset state. As an example, in the context of a rotating asset (e.g., a rotor), the asset state configuration property can be ranges of rotation speed of the asset 102 that define the respective asset states.

In an additional embodiment, the configuration property can be a system configuration related to the asset monitoring system 104 itself. The system configuration can adopt a variety of forms. In one example, the system configuration can relate to timekeeping by the asset monitoring system 104. For instance, the asset monitoring system 104 can be employ a network resource (e.g., a time server) for timekeeping, as compared to a local clock maintained by the asset monitoring system 104 (e.g., one or more processors of the asset monitoring system 104). Thus, a configuration property for timekeeping can be a network address of the time server. In another example, the system configuration can be a number of networks in communication with the asset monitoring system 104.

In operation 304, the configuration system can generate the GUI 116. An example of the GUI 116 is illustrated in FIG. 4. As shown, the GUI 116 can include a navigation window 400, a configuration window 402, and an error window 404.

The navigation window 400 can include a hierarchical list 406 of respective assets 102 monitored by the asset monitoring system 104. As shown, the hierarchical list 406 includes a plurality of levels, such as a system (asset monitoring system 104) level, a chassis level, and a channel level. The GUI 116 can be configured to receive an operator selection (e.g., operator input 120) of a level of the hierarchical list 406.

In an embodiment, the lowest level of the hierarchical list 406 can be a channel level. A channel can be respective ones of the sensors 108 of the asset monitoring system 104. Thus, selection of a channel of the channel level can include operational parameter measurement determined from the sensor signals 108s acquired by the selected channel.

The next higher level of the hierarchical list 406 can be a module level. A module can be respective ones of the circuits 210 of the asset monitoring system 104 and, as discussed above, can be in communication with one or more channels. Thus, selection of a module of the module level can include the operational parameter measurements determined by the selected module and logical processes performed thereby based upon the corresponding channels.

The next higher level of the hierarchical list 406 can be the chassis level. The chassis can be a physical frame housing at least a portion of the hardware modules (e.g., circuits 210) of the asset monitoring system 104. Thus, selection of a chassis of the chassis level can include the operational parameter measurements determined by modules of the selected chassis and logical processes performed thereby.

The highest level of the hierarchical list 406 can be the system level. Thus, selection of the system level includes all measurement determined by the asset monitoring system 104.

The configuration system 106 can determine the measurements associated with the selected hierarchical level. As an example, associations between respective ones of hierarchical list 406 and corresponding measurements can be maintained by the data storage device 112 (e.g., within a database). Thus, in response to receipt of an operator selection from the hierarchical list 406, the configuration system 106 can transmit a query to, and receive a response from, the data storage device 112 regarding the measurements corresponding to the selection from the hierarchical list 406.

Once configuration system 106 determines the operational parameter measurement(s) corresponding to the selection from the hierarchical list 406, it can further determine the at least one configuration property corresponding to respective measurements. As an example, associations between respective ones of the measurements and corresponding configuration properties can be maintained by the data storage device 112 (e.g., within a database). Thus, in response to receipt of the operator selection from the hierarchical list 406, the configuration system 106 can further transmit a query to, and receive a response from the data storage device 112 regarding the configuration properties corresponding to respective measurements.

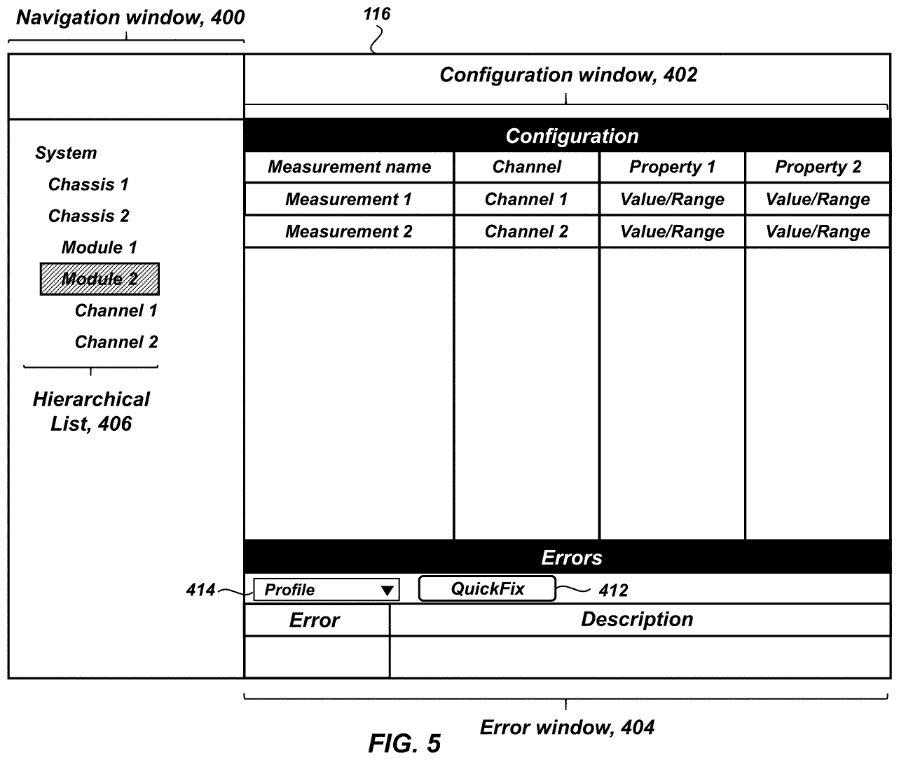

As illustrated in FIGS. 4-5, the configuration system 106 can further update the GUI 116 to include a first window (e.g., configuration window 402) that contains an identifier of at least measurement and one or more configuration properties corresponding to the measurement. As an example. The at least one measurement can be a measurement corresponding to the selection from the hierarchical list 406. Examples of the measurement identifier include a name of the measurement. Examples of the at least one configuration property can adopt a variety of forms, discussed in greater detail below.

Optionally, other information regarding the measurement can be included within the configuration window 402. Examples can include, but are not limited to, the measurement type (e.g., state measurement, relay channel, temperature, band pass, bias, vector, speed, etc.), a channel name, and a channel type (e.g., relay channel, temperature channel, radial vibration channel, speed channel, etc.) In certain embodiments, the measurement name and channel name can be the same as the measurement type and the channel type, respectively.

Optionally, other information regarding the configuration of the asset monitoring system 104 can be listed within the configuration window 402. As an example, a chassis can include a plurality of slots in which respective ones of the circuits 210 are positioned. The slot in which the circuit 210 that determines a respective operational parameter measurement can be listed in the entry for the corresponding measurement.

In operation 306, the GUI 116 can be output by the configuration system 106 to a display device for display of the GUI 116. As an example, the configuration system 106 can output the GUI 116 to the user computing device 112 and the GUI 116 can be displayed on a display device in communication with the user computing device 112.

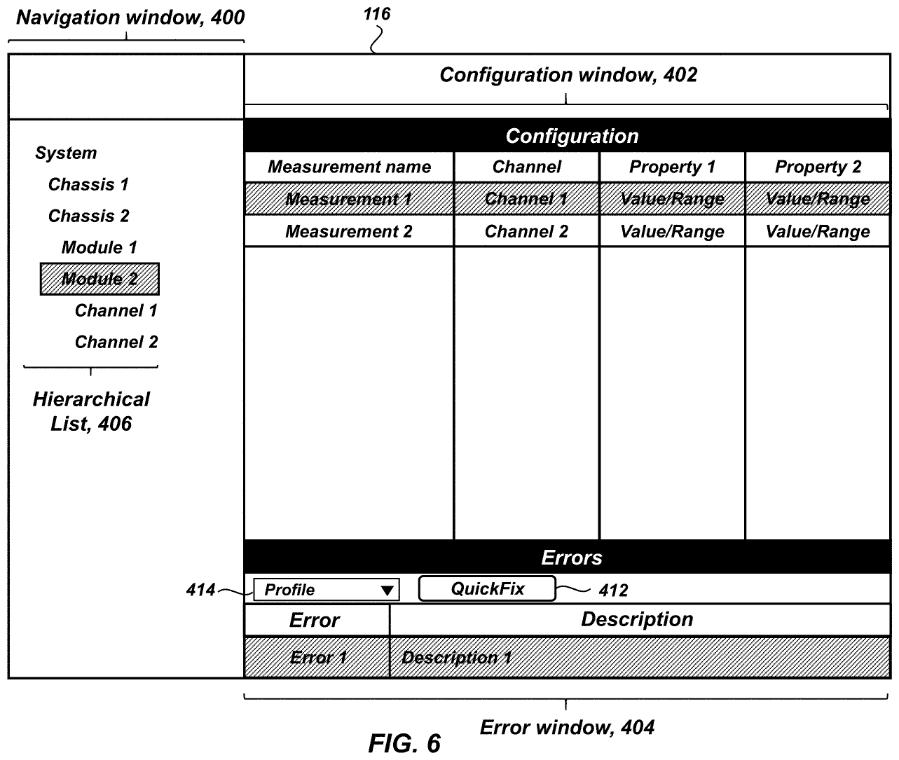

In operation 310, the configuration system 106 can validate the received configuration. As an example, the configuration system 106 can receive a selection of a measurement within the configuration window 402. As illustrated in FIG. 6, measurement 1 is selected.

The configuration system 106 can further compare a configuration property of the one or more configuration properties to a corresponding reference configuration property. As an example, the data storage device 112 can maintain a plurality of reference configuration properties associated with respective configuration properties, and the configuration system 106 can retrieve reference configuration properties from the data storage device in response to a query. At least one validation error can be determined by the configuration system 106 when a configuration property of the one or more configuration properties does not satisfy its corresponding reference configuration property. In certain embodiments, such satisfying can be achieved when a configuration property of the one or more configuration properties matches its corresponding reference configuration property

In one aspect, the reference configuration property can include a range of values. A match can occur when a value of the configuration property lies within or outside of the range of values, as appropriate. As discussed above, a configuration property of a sensor 108 can include a scale factor. In this context, the reference configuration property can be a linear range. A match can be determined when the scale factor lies within the linear range, while a match is not determined when the scale factor lies outside of the linear range

In another aspect, the reference configuration property can be a single value. A match can occur when a value of the configuration property is above, below, or equal to the reference configuration property, as appropriate. As discussed above, a configuration property of a sensor 108 can include a set point. In this context, the reference configuration property can be a full scale range of the sensor 108. A match can be determined when the set point lies within the full scale range, while a match is not determined when the set point lies outside of the full scale range.

In an additional aspect, the reference configuration property can be a numerical value of a specific type (e.g., an integer). A match can be determined when a value of the configuration property adopts the same number type as the reference configuration property. In contrast, a match is not determined when the value of the configuration property is not the same number type as the reference configuration property.

In a further aspect, the reference configuration property and the configuration property can each be Boolean values (e.g., 0 or 1, TRUE or FALSE, etc.). A match can be determined when the Boolean values of the configuration property and the reference configuration property are equal. In contrast, a match is not determined when the Boolean values of the configuration property and the reference configuration property are not equal

In certain embodiments, configuration properties can be designated as required or optional. In one aspect, a match is not determined when a value for a required configuration property is absent from the received configuration. A match can be determined when a value for a required configuration property is absent from the received configuration. A configuration property can be designated as required or optional as appropriate for the measurement.

In other embodiments, the configuration system 106 can detect a variety of other validation errors. Examples can include, but are not limited to:
Absence of a required component listed within the hierarchical list 406 (e.g., a chassis, a power input module (e.g., power input 280).
Listing of a required component in a slot of the chassis other than a predetermined slot (e.g., chassis in a slot other than a predetermined first slot, power input 280 in a slot other than a predetermined second slot).
Listing of two or more components in the same slot of the chassis.
Listing of two or more components when only one of that component should be present within the chassis (e.g., system interface module 276).
A channel is listed without an associated module (e.g., processing circuit 210p).
A module is listed without an associated channel.
The listed channel is not recommended for the corresponding measurement (e.g., an accelerometer channel indicated for a.
Duplicate naming of respective operational parameter measurements.
Use of one or more invalid characters in any information presented in the GUI 116.

It can be appreciated that the validation errors discussed above are presented for example only. Other criteria for use in determining whether or not a match is present, and whether or not a validation error is determined, can be employed without limit.

The configuration system 106 can be further configured to update the GUI 116 to include the at least one validation error corresponding to the selected measurement in a second window (e.g., the error window 404). As shown in FIG. 6, each of the at least one validation error can be displayed within the GUI 116 as a separate entry of a list. Each entry can include a name of the validation error and a description of the validation error. In further embodiments, the entry can include other information regarding the listed validation error. In one aspect, the additional information can include the path of the selection from the hierarchical list 406 corresponding to the selected measurement (e.g., Chassis>Module>Channel>Measurement). In another embodiment, the additional information can include a configuration profile corresponding to the validation error, as discussed in greater detail below.

In operation 312, the configuration system 106 can be configured to correct one or more validation errors corresponding to the selected measurement. As illustrated in FIG. 6, the configuration system 106 can receive a selection of a validation error of the at least one validation error within the error window 404 (e.g., operator input 120) via the user computing device 110.

In response to receipt of the validation error selection, the configuration system 106 can be configured to determine at least one corresponding correction. As an example, the data storage device 112 can include data associating respective validation errors and corrections. Thus, the configuration system 106 can query the data storage device 112 to receive one or more corrections corresponding to the selected validation error.

Embodiments of the at least one correction can adopt a variety of forms, depending upon the nature of the corresponding validation error. As discussed above, the validation error can be the lack of a match between a value or value range of a configuration property as compared to its corresponding reference configuration property. Under these circumstances, the at least one correction can be an updated configuration property including a value or value range that matches the reference configuration property.

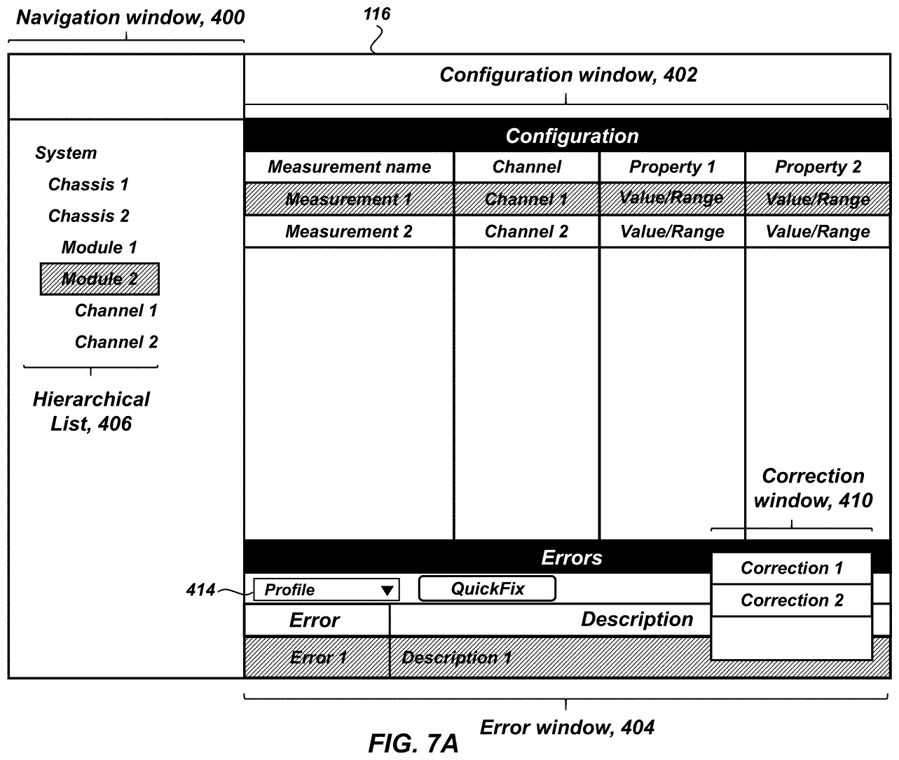

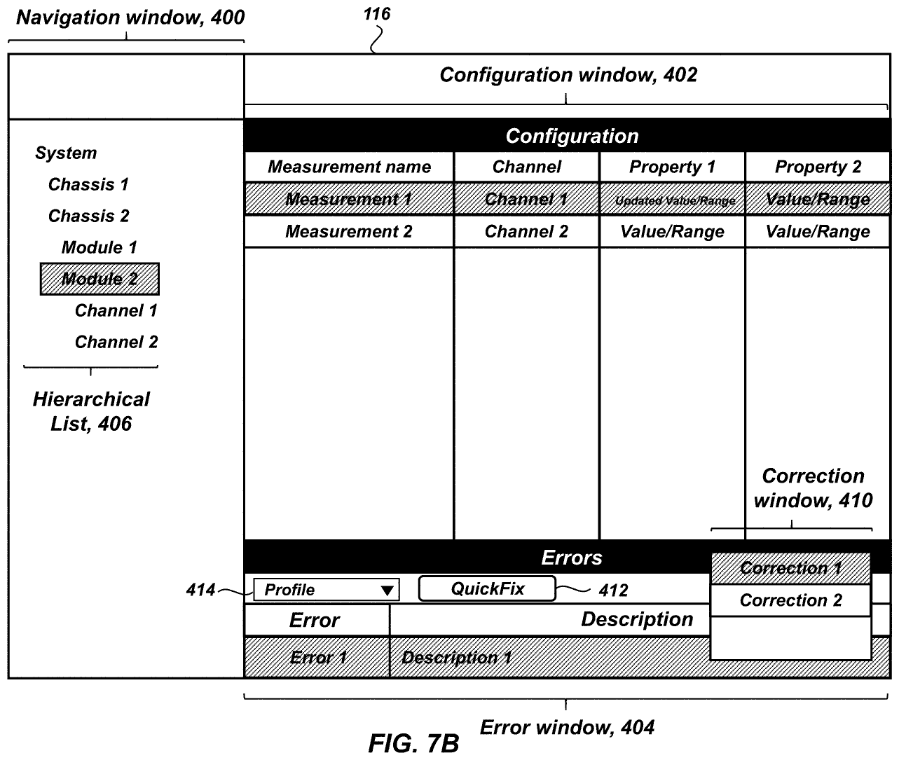

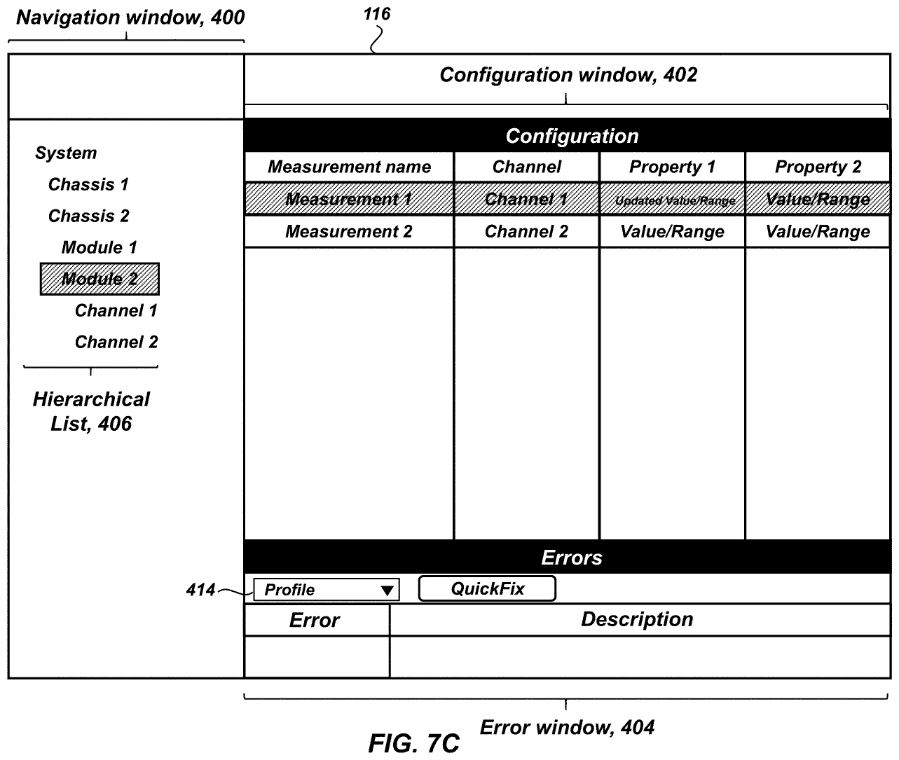

As further illustrated in FIG. 7A, the configuration system 106 can update the GUI 116 to include a third window (e.g., a correction window 410) in response to receipt of a first selection of a validation error within the error window 404. The first selection can be a predetermined interaction between the operator and a listed validation error within the error window 404. Examples can include, but are not limited to, a single right mouse click, a single left mouse click, a double mouse click (e.g., a double right mouse click), etc. It can be appreciated that, in the context of touch sensitive display devices, mouse clicks can be used interchangeably with tapping on a screen of the display.

The correction window 410 can include the at least one correction corresponding to the selected validation error. As shown, the at least one correction can be displayed as a separate entry of a list. Each entry can include a description of the listed correction. In further embodiments, the entry can include other information regarding the listed validation error without limit.

In certain embodiments, upon receipt of the first selection of a correction from the at least one correction, the at least one correction can be implemented by the configuration system 106. Continuing the example above, the at least one correction can be an updated value/range of property 1 for measurement 1 with an updated value/range. As illustrated in FIG. 7B, the configuration system 106 can update the GUI 116 to display the updated configuration property (value/range) in the appropriate field of the configuration window 402. After selection of the correction, the configuration system 106 can further update the GUI 116 to remove display of the selected validation error (e.g., error 1) from the error window, as illustrated in FIG. 7C. The configuration system 106 can additionally transmit the updated configuration property to the asset monitoring system 104.

In other embodiments, the configuration system 106 can be configured for manual entry of the at least one correction (e.g., via the user computing device 110). As an example, the GUI 116 can be configured to receive a second selection of the validation error, different from the first selection. The second selection can be a predetermined interaction between the operator and a listed validation error within the error window 404. Examples of the second selection can include, but are not limited to, a single right mouse click, a single left mouse click, a double mouse click (e.g., a double right mouse click), etc. It can be appreciated that, in the context of touch sensitive display devices, mouse clicks can be used interchangeably with tapping on a screen of the display.

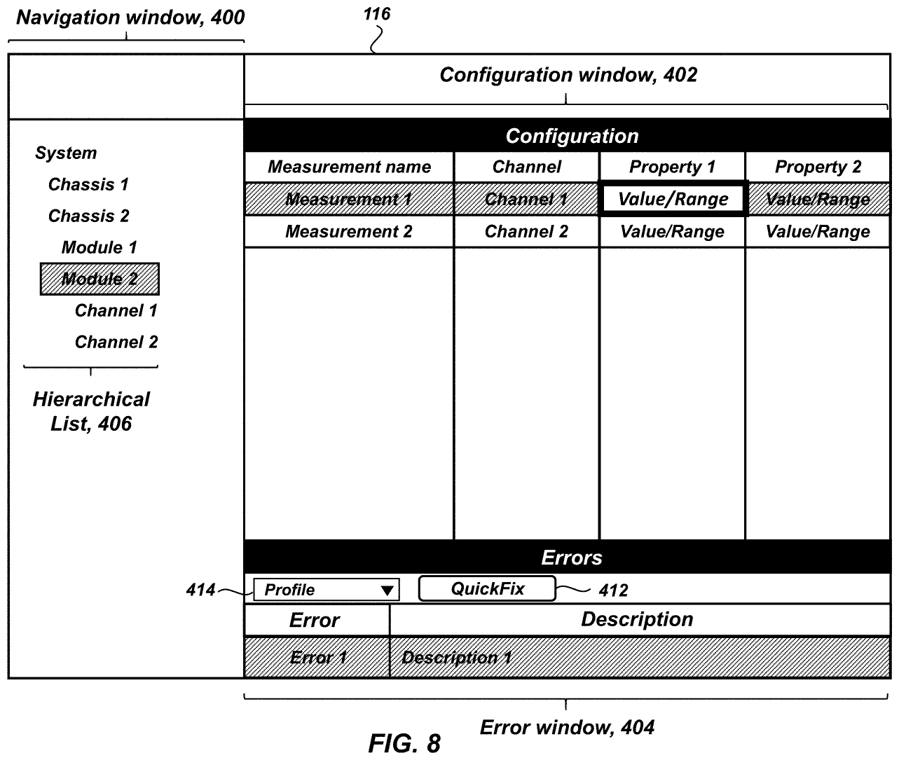

In contrast to the first selection, the second selection can result in navigation within the GUI 116 to a portion of the GUI 116 containing the configuration property corresponding to the selected error. As an example, the navigation can highlight a field within the configuration window 402 (e.g., designating the highlighted field as an active field for receipt of input) containing the configuration property corresponding to the selected error. For example, as illustrated in FIG. 8, the navigation highlights the field corresponding to configuration property 1 of measurement 1. Following this navigation, the configuration system 106 can be further configured to receive input of an updated configuration property corresponding to the selected error within the highlighted field.

Beneficially, the ability to navigate in this manner can provide significant time savings and improved user experience. Notably, the operator is saved the trouble of manually finding and navigating to the field, which can be particularly troublesome when the operator is required to correct multiple validation errors.

Following receipt of the correction within the highlighted field, the correction can be implemented by the configuration system 106. Continuing the example above, correction can be an updated value/range of property 1 for measurement 1 with an updated value/range. As discussed above, the configuration system 106 can update the GUI 116 to display the updated configuration property (value/range) in the highlighted field of the configuration window 402, as illustrated in FIG. 7B. After manual entry of the correction, the configuration system 106 can further update the GUI 116 to remove display of the selected validation error (e.g., error 1) from the error window, as illustrated in FIG. 7C. The configuration system 106 can additionally transmit the updated configuration property to the asset monitoring system 104.

It can be appreciated that, in certain embodiments, the at least one correction can include disabling the selected configuration property. Disabling can mean maintaining the original configuration property but removing the configuration property from runtime processing (e.g., analysis or other calculations to determine a measurement). The option to disable the selected configuration property can be available for measurements that can employ but do not require the disabled configuration property. In one aspect, the operator can disable the selected configuration property via one of the corrections within the correction window, as illustrated in FIG. 7A. After this correction is selected, the configuration system 106 can further update the GUI 116 to remove display of the selected validation error from the error window, as illustrated in FIG. 7C. The configuration system 106 can additionally transmit information operative to disable the updated configuration property to the asset monitoring system 104.

In certain embodiments, it can be desirable to automate correction of validation errors in order to save time and improve the operator experience. Thus, in certain embodiments, the configuration system 106 can include a user interface object 412 that automatically implements validation error corrections (e.g., a “Quick Fix” button 412) upon selection. In certain embodiments, selection of the Quick fix button 412 can cause the configuration implement a correction only for a validation error selected within the error window. In further embodiments, when no validation error is selected within the error window, the Quick fix button can be disabled, preventing the configuration system from implementing a correction via selection of the Quick fix button. In alternative embodiments, when no validation error is selected within the error window, the Quick fix button can be enabled and, when selected, it can cause the configuration system to implement a correction for each of the validation errors listed in the error window.

Under circumstances where only a single correction is determined for a validation error, the configuration system 106 can readily implement this single correction when the Quick fix button is selected. However, under circumstances where multiple corrections are determined for a given validation error, the configuration system 106 can require a mechanism to identify which correction to implement from a list of multiple correction options. Accordingly, embodiments of the determined corrections can further be associated with a profile.

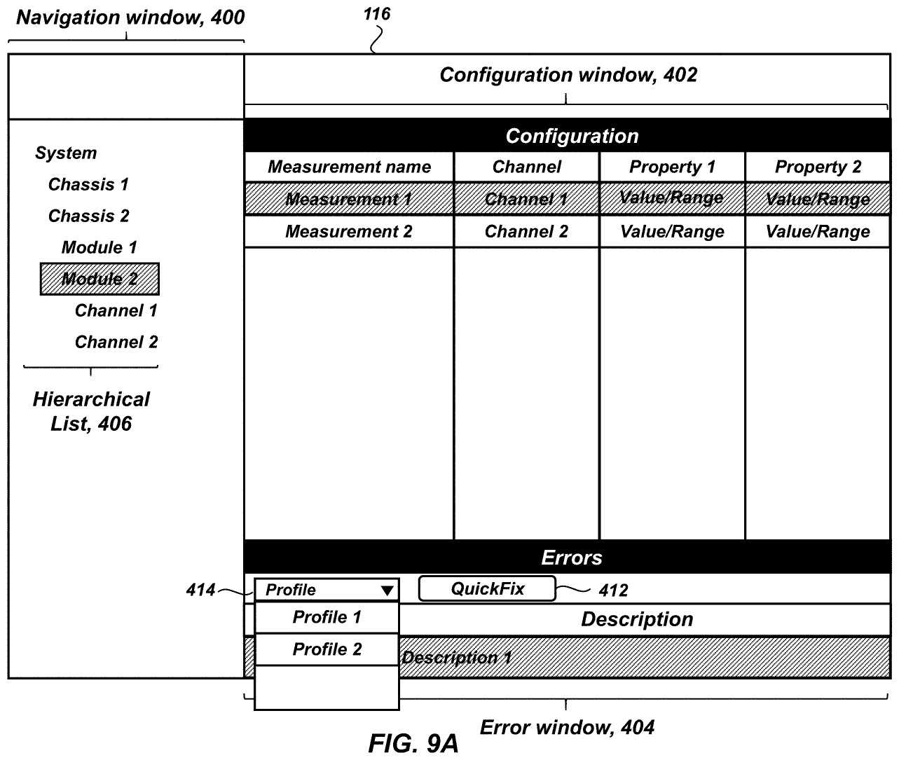

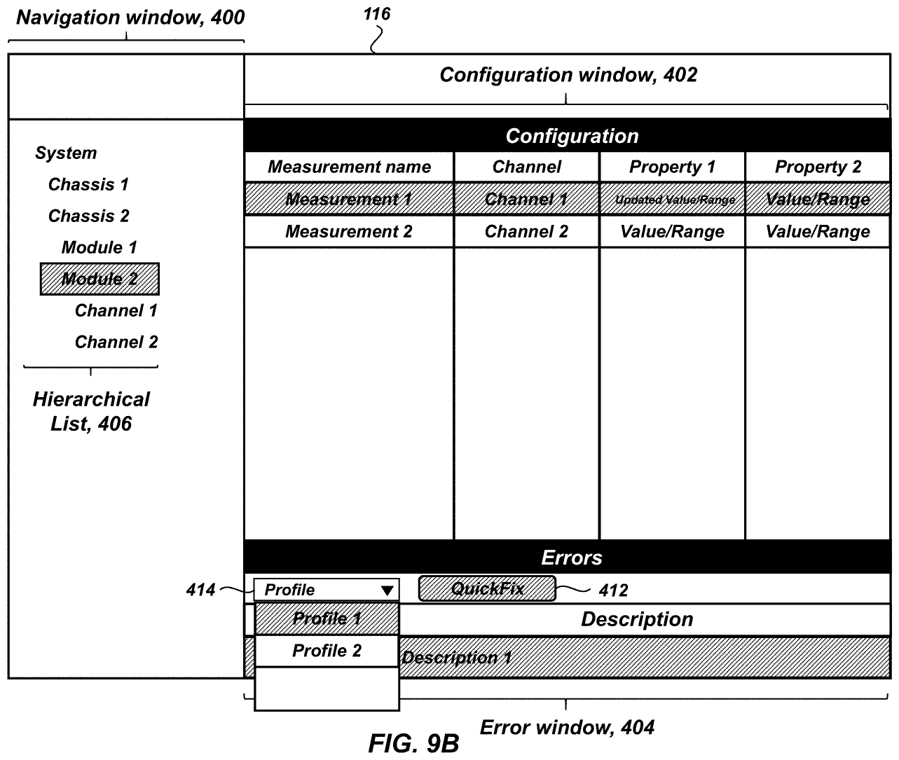

As illustrated in FIG. 9A, The GUI 116 generated by the configuration system 106 can further include a user interface object 414 that allows for selection of a configuration profile from a menu listing multiple configuration profiles (e.g., a profile menu). As shown, the profile menu 414 can be positioned within the error window 404. However, in alternative embodiments, the profile menu can be positioned in another location within the GUI. In use, prior to selection of the Quick fix button 412, the configuration system 106 can receive a configuration profile selection within the GUI (e.g., via a selection from the profile menu 414).

For a given validation error, upon selection of the Quick fix button 142, as illustrated in FIG. 9B, the configuration system 106 can automatically select the correction from the determined corrections for the selected validation error that corresponds to the selected configuration profile. That is, the automatically selected correction is a default correction for the selected configuration profile. As discussed above, determined corrections can include an updated configuration property. Thus, in certain embodiments, the configuration can be updated to replace the configuration property with the updated configuration property corresponding to the automatically selected correction.

Following selection of the Quick fix button 412, the configuration system 106 can further update the GUI 116 to display the updated configuration property (value/range) in the configuration window 402, as discussed above and illustrated in FIG. 7B. The configuration system 106 can further update the GUI 116 to remove display of the selected validation error from the error window 406, as discussed above and illustrated in FIG. 7C. The configuration system 106 can additionally transmit the updated configuration property to the asset monitoring system 104.

As discussed above, the asset 102 can operate in a variety of states (e.g., startup, shutdown, steady state, etc.) It can be appreciated that the recommended corrections defined by respective configuration profiles can vary, depending upon the asset state. Thus, in certain embodiments, each configuration profile can be further associated with an asset state. When performing automatic correction (e.g., selecting the Quick fix button 412), the configuration system 106 can further select the configuration profile based upon the asset state. As an example, the configuration system can receive a ruleset and determine the asset state based upon the ruleset. As an example, the ruleset can specify rotation speeds associated with each of the asset states. Thus, the asset state can be determined from measurements of the asset rotation speed. Once the asset state is determined, the configuration system can further select the configuration profile that corresponds to the determined asset state.

In certain embodiments, while use of the Quick fix button 412 can be desirable to automatically implement validation error corrections, it can also be beneficial for an operator to review and approve the default corrections prior to implementation. Accordingly, in an embodiment, after selection of the Quick fix button 412, the configuration system 106 can be configured to update the GUI 116 to include an acknowledgement window 1000. The acknowledgement window 1000 can include a list of the validation errors to be corrected in response to selection of the Quick fix button 412, the corrections determined for each of the validation errors, and a selection region 1002 allowing selection of respective corrections. The acknowledgment window 1100 can include, within the selection region 1002, the correction for each validation error associated with the selected configuration profile (e.g., an automatically selected default correction).

Under circumstances where the operator is satisfied with the selected corrections, the operator can approve the selected corrections without change (e.g., selection of an “OK” button without making changes within the selection region.) Alternatively, if the operator is not satisfied with one or more of the selected corrections, the operator can approve a change to the correction for one or more of the validation errors (e.g., selection of the “OK” button after making changes within the selection region.) That is, the selected correction implemented by the configuration system 106 can be the automatically selected default correction under circumstances where the operator makes no changes within the acknowledgement window 1000. Alternatively, the selected correction implemented by the configuration system 106 for a validation error can be an updated correction under circumstances where the operator updates the correction associated with the validation error within the acknowledgement window 1000.

In certain embodiments, when an operator changes one or more of the corrections from the default selections, the configuration system 106 can record the operator's authorization for this change. Recording the operator authorization can include, but is not limited to, recording a unique identifier of the operator (e.g., an operator name, operator number, etc.), the changed correction, the date/time at which the change is authorized, etc. Such recorded information can be transmitted from the configuration system 106 to the asset monitoring system and/or the data storage device 112 for storage and subsequent retrieval.

As discussed above, the default selections can represent recommended corrections determined by the manufacturer and/or operator of the asset monitoring system 104. Thus, an operator should only authorize changes from the default selections for good cause. By recording when an operator changes one or more of the corrections from the default selections, in the event that this change is found to be mistaken or inappropriate, it can be relatively easy to identify the authorizing operator in an audit.

Exemplary technical effects of the methods, systems, and devices described herein include, by way of non-limiting example improved configuration of asset monitoring systems. Configuration errors can be quickly identified, along with possible corrections. Recommended corrections reflecting domain knowledge and best practices can be implemented automatically to resolve configuration errors. This automation can significantly reduce the amount of time required for configuring an asset monitoring system, as it can help operators address errors that they would otherwise spend more time resolving manually. Furthermore, configuration best practices can be codified, reducing the level of domain knowledge required by operators to resolve configuration errors.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A method, comprising:
receiving, by a configuration system including one or more processors, a configuration including at least one configuration property corresponding to a measurement determined by an asset monitoring system configured to monitor an asset;
generating, by the configuration system, a graphical user interface (GUI) including a first window containing an identifier of the measurement and one or more configuration properties corresponding to the measurement;
providing, by the configuration system, the GUI to a display device for display of the GUI;
validating, by the configuration system, the received configuration, including:
receiving a selection of a measurement within the first window of the GUI;
comparing a configuration property of the one or more configuration properties to a corresponding reference configuration property; and
determining at least one validation error for the selected measurement when a configuration property of the one or more configuration properties does not satisfy its corresponding reference configuration property;
updating the GUI to include the at least one validation error corresponding to the selected measurement within a second window; and
determining, by the configuration system, a validation error of the at least one validation error corresponding to the selected measurement by:
receiving a selection of a validation error from the at least one validation error within the second window; and
providing a third window within the GUI, the third window listing at least one correction corresponding to the selected validation error.

2. The method of claim 1, wherein the at least one correction includes an updated configuration property for the measurement or component, and wherein the method further comprises, by the configuration system:
receiving, a selection of a correction from the at least one correction within the third window;
updating the configuration to replace the configuration property with an updated configuration property corresponding to the selected correction;
updating the GUI to include the updated configuration property within the first window and to remove display of the selected validation error within the second window; and
transmitting the updated configuration property to the asset monitoring system.

3. The method of claim 1, wherein the GUI is configured to, upon receipt of a second selection of a validation error, provide a portion of the first window containing the configuration property corresponding to the selected error in the GUI, and wherein the method further comprises, by the configuration system:
receiving the second selection;
receiving input of an updated configuration property corresponding to the selected error within the portion of the first window;
updating the configuration to replace the configuration property with the updated configuration property;
updating the GUI to include the updated configuration property within the first window and to remove the selected validation error from the second window; and
transmitting the updated configuration property to the asset monitoring system.

4. The method of claim 1, wherein the at least one correction disables the selected configuration property, and wherein the method further comprises, by the configuration system:
receiving a selection of one of the at least one correction within the third window;
updating the GUI to remove the selected at least one validation error from the second window; and
transmitting information operative to disable the selected configuration property to the asset monitoring system.

5. The method of claim 1, wherein each of the at least one correction is associated with a profile, and wherein the at least one correction is an updated configuration property corresponding to the selected measurement, and wherein the method further comprises, by the configuration system:
receiving a selection of a configuration profile from a list of configuration profiles;
automatically selecting the correction from the at least one correction associated with the selected configuration profile;
updating the configuration to replace the configuration property with the updated configuration property corresponding to the selected correction;
updating the GUI to include the updated configuration property within the first window and remove the selected validation error from the second window; and
transmitting the updated configuration property to the asset monitoring system.

6. The method of claim 5, wherein each configuration profile is associated with a state of the asset and wherein the method further comprises, by the configuration system:
receiving a ruleset;
determining a state of the monitored asset based upon the ruleset; and
selecting the configuration profile that corresponds to the determined asset state.

7. The method of claim 5, further comprising, by the configuration system prior to updating the configuration:
updating the GUI to include a fourth window displaying each correction corresponding to the selected validation error and the automatically selected correction,
wherein the fourth window is further configured to receive a user input of an updated correction different from the automatically selected correction, and
wherein the selected correction is the automatically selected correction absent receipt of the updated correction and wherein the selected correction is the updated correction when the updated correction is received.

8. The method of claim 7, further comprising receiving user input confirming the displayed correction associated with the selected configuration profile prior to updating the configuration of the hardware component.

9. The method of claim 1, wherein the configuration property comprises at least one of a scale factor, a linear range, a frequency response, or a health limit for a sensor in communication with the asset monitoring system.

10. The method of claim 1, wherein the configuration property comprises at least one of a type of measurement or observation information defining at least a portion of the measurement to be observed.

11. The method of claim 1, wherein the configuration parameter is at least one set point corresponding to a respective operating parameter measurement determined by the asset configuration system.

12. A system comprising:
a display device;
a memory storing non-transitory computer-readable and executable instructions, and
at least one processor communicatively coupled to the memory and configured to execute the instructions, which when executed cause the at least one processor to
receive a configuration including at least one configuration property corresponding to a measurement determined by an asset monitoring system configured to monitor an asset;
generate a graphical user interface (GUI) including a first window containing an identifier of the measurement and one or more configuration properties corresponding to the measurement;
provide the GUI to the display device for display of the GUI;
validate the received configuration, wherein validating the received configuration includes:
receiving a selection of a measurement within the first window of the GUI;
comparing a configuration property of the one or more configuration properties to a corresponding reference configuration property; and
determining at least one validation error for the selected measurement when a configuration property of the one or more configuration properties does not satisfy its corresponding reference configuration property;
update the GUI to include the at least one validation error corresponding to the selected measurement within a second window; and
determine a validation error of the at least one validation error corresponding to the selected measurement by:
receiving a selection of a validation error from the at least one validation error within the second window; and
providing a third window within the GUI, the third window listing at least one correction corresponding to the selected validation error.

13. The system of claim 12, wherein the at least one correction includes an updated configuration property for the measurement or component, and wherein the instructions cause the at least one processor to perform operations further including
receiving, a selection of a correction from the at least one correction within the third window;
updating the configuration to replace the configuration property with an updated configuration property corresponding to the selected correction;
updating the GUI to include the updated configuration property within the first window and to remove display of the selected validation error within the second window; and
transmitting the updated configuration property to the asset monitoring system.

14. The system of claim 12, wherein the GUI is configured to, upon receipt of a second selection of a validation error, provide a portion of the first window containing the configuration property corresponding to the selected error in the GUI, and wherein the instructions cause the at least one processor to perform operations further including
receiving the second selection;
receiving input of an updated configuration property corresponding to the selected error within the portion of the first window;
updating the configuration to replace the configuration property with the updated configuration property;
updating the GUI to include the updated configuration property within the first window and to remove the selected validation error from the second window; and
transmitting the updated configuration property to the asset monitoring system.

15. The system of claim 12, wherein the at least one correction disables the selected configuration property, and wherein the instructions cause the at least one processor to perform operations further including
receiving a selection of one of the at least one correction within the third window;
updating the GUI to remove the selected at least one validation error from the second window; and
transmitting information operative to disable the selected configuration property to the asset monitoring system.

16. The system of claim 12, wherein each of the at least one correction is associated with a profile, and wherein the at least one correction is an updated configuration property corresponding to the selected measurement, and wherein the instructions cause the at least one processor to perform operations further including
receiving a selection of a configuration profile from a list of configuration profiles;
automatically select the correction from the at least one correction associated with the selected configuration profile;
updating the configuration to replace the configuration property with the updated configuration property corresponding to the selected correction;
updating the GUI to include the updated configuration property within the first window and remove the selected validation error from the second window; and
transmitting the updated configuration property to the asset monitoring system.

17. The system of claim 16, wherein prior to updating the configuration, the instructions cause the at least one processor to perform operations further including
updating the GUI to include a fourth window displaying each correction corresponding to the selected validation error and the automatically selected correction,
wherein the fourth window is further configured to receive a user input of an updated correction different from the automatically selected correction, and
wherein the selected correction is the automatically selected correction absent receipt of the updated correction and wherein the selected correction is the updated correction when the updated correction is received.

18. The system of claim 17, wherein the instructions cause the at least one processor to perform operations further including receiving a user input confirming the displayed correction associated with the selected configuration profile prior to updating the configuration of the hardware component.

19. The system of claim 12, wherein the configuration property comprises at least one of a scale factor, a linear range, a frequency response, or a health limit for a sensor in communication with the asset monitoring system.

20. The system of claim 12, wherein the configuration property comprises at least one of a type of measurement or observation information defining at least a portion of the measurement to be observed.
